(19) United States
(12) Patent Application Publication
(10) Pub. No.: US 2006/0236004 A1
(43) Pub. Date: Oct. 19, 2006

(54) Computer System Capable of Rapidly Transmitting Data between Different Storage Devices

(76) Inventors: Shan-Yi Yang, Delta, BC (CA); Yum-Cheng Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,846

(22) Filed: Aug. 18, 2005

(30) Foreign Application Priority Data
Apr. 14, 2005 (CN) 200510065202.5

(51) Int. Cl. G06F 13/38

(52) U.S. Cl. 710/66

(57) ABSTRACT

A computer system includes a first storage device, a second storage device, a programmable device for converting formats of data stored in the first storage device and the second storage device, a first bus for transmitting data between the first storage device and the programmable device, a second data bus for transmitting data between the second storage device and the programmable device, a control bus, the first storage device and the second storage device, and a central processing unit for outputting a control signal to the programmable device, the first storage device and the second storage device via the control bus. The programmable device can reduce data transmission time and workload of the central processing unit and increase the efficiency of the computer system.

### BACKGROUND OF THE INVENTION

1. Field of the Invention

The present invention relates to a computer system capable of rapidly transmitting data between different storage devices, more particularly, a programmable device utilized as a processing unit capable of rapidly transmitting data between different storage devices in the computer system.

2. Description of the Prior Art

In the modern information society, computer systems have become an essential tool. In many forms, such as, a personal desktop computer, a personal notebook, or a server, the computer system's utilization in terms of operation and time has increased tremendously.

Please refer to FIG. 1. FIG. 1 illustrates a functional block diagram of a conventional computer system 10. The computer system 10 comprises a central processing unit (CPU) 12, a north bridge circuit 14, a south bridge circuit 16, a main memory 18, a hard disk 20, and an optical disc drive 22. The CPU 12 controls the operations of the computer system 10, the north bridge circuit 14 controls the data transmission between high-speed peripheral devices (e.g., a display controller (not shown in FIG. 1) and the main memory 18) and the CPU 12, and the south bridge circuit 16 controls the data transmission between low-speed peripheral devices (e.g., the hard disk 20 and the optical disc 22) and the north bridge circuit 14. Furthermore, the main memory 18 is a data storage device, utilized for storing volatile data, the hard disk 20 and the optical disc drive 22 are also data storage devices utilized for storing non-volatile data.

The main memory 18 is a system memory of the computer system 10. In general, the main memory 18 comprises a plurality of memory cells 24 arranged in arrays, each memory unit 24 corresponds to a column address and a row address. When the computer system 10 operates, the CPU 12 loads data stored in the main memory 18 to a register 26 in the CPU 12, the data held in the register 26 is then processed and sent back to the main memory 18. As known to those skilled in the prior art, the accessing operation of the data stored in the memory 18 is processed via a memory controller 28 of the north bridge circuit 14. The data transmission between the above-mentioned components and the main memory 18 must be transmitted through the memory controller 28 regardless of weather it is the CPU 12, the hard disk 22 or the optical disc drive 24. In general, the memory controller 28 comprises an address register 30 and a data register 32, where the address register 30 is for storing memory addresses and the data register 34 is for storing data to be written in the main memory 18 and data retrieved from the main memory 18. For example, when the CPU 12 transmits calculation data in the register 26 to be stored in the plurality of memory cells 24 of the main memory 18 a series of events occur: the CPU 12 will output the corresponding address data of the plurality of memory cells 24 to the address register 30, the CPU 12 will output the calculation data to the data register 32, the memory controller 28 will access the plurality of memory cells 24 according to the address data recorded in the address register 30, and the calculation data stored in the data register 32 will write-in to the plurality of memory cells 24. Similarly, when the CPU 12 downloads calculation data recorded in the plurality of memory cells 24 of the main memory 18 to the register 26 a series of events occur: the CPU 12 will output address data of the corresponding plurality of memory cells 24 to the address register 30, the memory controller 28 will access the plurality of memory cells 24 according to the address data recorded in the address register 30, and the calculation data stored in the memory cells 24 will be read and stored into the data register 32, lastly, the memory controller 28 will transmit the calculation data recorded in the data register 32 to the register 26 of the CPU 12.

As is well known by those skilled in the art, the memory controller 28 must write the memory cell 24 of the main memory 18 via a physical memory address. Note that when the computer system 10 executes a program that the program utilizes a logical memory address to write the main memory 18, therefore an operating system (OS) executed by the computer system 10 comprises a memory management unit to control conversion between the logical memory address and the physical memory address. For example, when the program writes the memory cell 24a, the CPU 12 executes the OS to obtain the physical memory address of the memory cell 24a and the OS outputs the physical memory address to the address register 30 so that the memory controller 28 can write the memory cell 24a according to the physical memory address.

When the user wants to transmit data between different storage devices, for example, when data stored in the hard disk 20 is transmitted to optical storage media (e.g., such as CD and DVD) of the optical disc drive 22, or data stored in the optical storage media of the optical disc 22 is transmitted to the hard disk 20, firstly the CPU 12 will output a control signal to a data transmission source storage device and to a data transmission destination storage device to set initial condition between the data transmission source storage device and the data transmission destination storage device. For example, if a data bit D stored in the hard disk 20 is transmitted to the optical storage media of the optical disc drive 22, the CPU 12 will output the control signal to the hard disk 20 and the optical disc drive 22 to set the initial condition of the data transmission between the hard disk 20 and the optical disc drive 22, the hard disk 20 will then transmit the data bit D to the CPU 12 via a data bus (not shown in FIG. 1), as the CPU 12 needs to execute a data format conversion on the data bit D (e.g., switching the hard disk storage format header of the data bit D to the optical disc storage format header), the CPU 12 will then execute and temporarily store the data format conversion of the data bit D in the main memory 18, and the CPU 12 continues to process the next set of data, the data bit D temporarily stored in the memory cell 24 of the main memory is accessed via the address register 30 and the data register 32 of the memory controller 28. Lastly, the data bit D after data format conversion is transmitted to the optical disc drive 22.

In the above-mentioned, in the process of transmitting data between different storage devices, the process requires the CPU 12, the memory controller 28 and the main memory 18 to execute the data format conversion of the data bit D. Additionally, the CPU 12 must consume a plurality of clock cycles to process the operation of downloading the data bit D stored in the data register 32 into the register 26 and to process the operation of transmitting the data bit D stored in the register 26 to the data register 32. Furthermore, the operation in the above-mentioned, the transmission of the data bit D consumes the bandwidth of the front-side bus (FSB) between the CPU 12 and the north bridge circuit 14 as a result of the increasing load on the CPU 12. In addition, the data transmission source storage device transmits data to the CPU 12 via the data bus and the CPU 12 transmits data to the data transmission destination storage device via the data bus. This transmission structure is known as a unidirectional data transmission type. This means that the data is unable to be simultaneously transmitted from the data transmission source to the CPU and from the CPU to the data transmission destination. Please refer to FIG. 2. FIG. 2 illustrates a diagram of a conventional computer system 10 when a hard disk 20 transmits data to an optical disc drive 22. As the structure of reading and transmitting data of the CPU 12 is the unidirectional data transmission type, the whole data transmission time will be delayed. As mentioned previously, the conventional computer system 10 is concerned mainly with the transmission of data bit D, it utilizes the execution time of the CPU 12 and it increases the work load of the CPU 12, also the computer system 10 consumes the limited bandwidth of the front-side bus (FSB) between the CPU 12 and the north bridge circuit 14, therefore it causes a waste of resources in the computer system 10.

### SUMMARY OF THE INVENTION

The claimed invention provides a programmable device utilized as a processing unit capable of rapidly transmitting data between different storage devices in the computer system.

The claimed invention discloses a computer system capable of rapidly transmitting data between different storage devices, the computer system comprising: a first storage; a second storage device; a programmable device for converting formats of data stored in the first storage device and the second storage device; a first data bus coupled to the first storage device and the programmable device for transmitting data between the first storage device and the programmable device; a second data bus coupled to the second storage device and the programmable device for transmitting data between the second storage device and the programmable device; a control bus coupled to the programmable device, the first storage device and the second storage device; and a central processing unit coupled to the first storage device, the second storage device and the programmable device for outputting a control signal to the programmable device, the first storage device and the second storage device via the control bus to set initial condition of the data transmission between the first storage device and the second storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a conventional computer system.

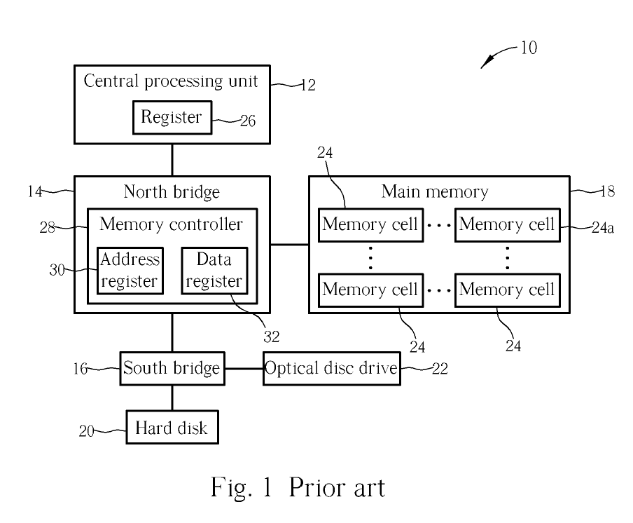

FIG. 2 illustrates a transmission time diagram of a conventional computer system when a hard disk transmits data to an optical disc drive.

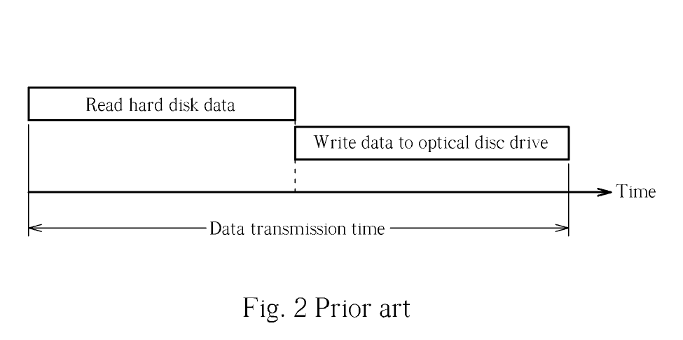

FIG. 3 illustrates a functional block diagram of a computer system according to the present invention.

FIG. 4 illustrates a flowchart of a first storage device transmitting data to a second storage device of the computer system.

FIG. 5 illustrates a transmission time diagram of a first storage device transmitting data to a second storage device 56 of a computer system.

### DETAILED DESCRIPTION

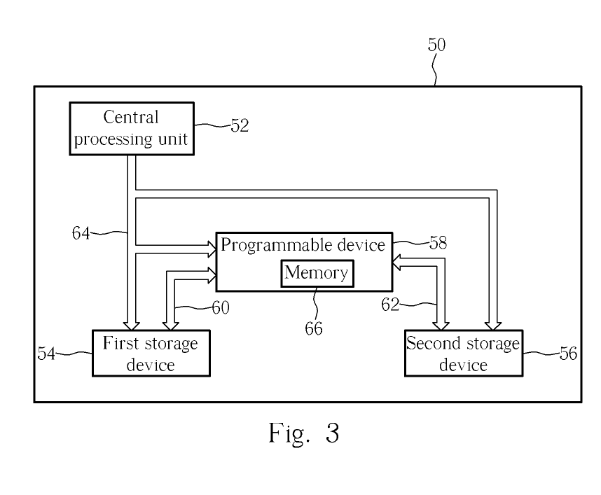

Please refer to FIG. 3. FIG. 3 illustrates a functional block diagram of a computer system 50 according to the present invention. The computer system 50 comprises a central processing unit (CPU) 52, a first storage device 54, a second storage device 56, a programmable device 58, a first data bus 60, a second data bus 62, and a control bus 64. The CPU 52 is utilized for controlling the operations of the computer system 50 and is also coupled to the first storage device 54, the second storage device 56, and the programmable device 58; the first storage device 54 and the second storage device 56 can be information storage devices, such as hard disk, optical storage media (e.g., CD, DVD and so on), or floppy disk and so on; the programmable device 58 can be a complex programmable logic device (CPLD), a field programmable gate array (FPGA), or an application specific integrated circuit (ASIC) and so on, the programmable device 58 is utilized for converting formats of data stored in the first storage device and the second storage device, the programmable device 58 comprising a memory 66, for temporarily storing data; the first data bus 60, coupled to the first storage device 54 and the programmable device 58, utilized for transmitting data between the first storage device 54 and the programmable device 58, the first bus can be an integrated drive electronics (IDE) interface, an AT attachment (ATA) interface or other type of data transmission interface; and the second data bus 62 is coupled to the second storage device 56 and the programmable device 58 and is utilized for transmitting data between the second storage device 56 and the programmable device 58, the second data bus can be the IDE interface, the ATA interface or other type of data transmission interface; the control bus 64 is coupled to the CPU 52, the programmable device 58, the first storage device 54 and the second storage device 56, and the CPU 52 is capable of outputting a control signal to the programmable device 58, the first storage device 54 and the second storage device 56 via the control bus 64 to set initial condition of the data between the first storage device 54 and the second storage device 56.

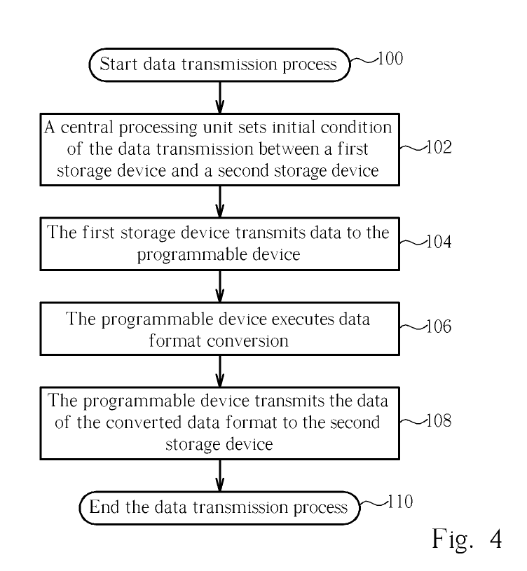

Please refer FIG. 4. FIG. 4 illustrates a flowchart of a first storage device 54 transmitting data to a second storage device 56 of the computer system. The flow of the first storage device 54 transmitting data to the second storage device 56 comprises the following steps:

Process 100: Start data transmission process.

Process 102: A CPU 52 outputs a control signal to a programmable device 58, a first storage device and a second storage device via a control bus to set initial condition of the data transmission between the first storage device and the second storage device.

Process 104: The first storage device 54 transmits data to the programmable device 58 via a first data bus 60.

Process 106: The programmable device 58 converts data format of the data transmitted from the first storage device 54 to a corresponding data format of the second storage device 56 via a corresponding data format of the first storage device 54.

Process 108: The programmable device 58 transmits the data of the converted data format in step 106 to the second storage device 56 via a second data bus 62.

Process 110: End the data transmission process.

A detailed explanation will be discussed about the above-mentioned process, when the user wants to transmit data between different storage devices (e.g., the first storage device 54 and the second storage device 56), for example backing up the data stored in the hard disk to the optical storage media of the optical disc drive, or backing up the data stored in the optical storage media of the optical disc drive to the hard disk. First, the CPU 52 sends out a control command to the data transmission source of the first storage device 54 and the data transmission destination of the second storage device 56 via the control bus 64 to set the initial condition of the data transmission between the data transmission source of the first storage device 54 and the data transmission destination of the second storage device 56. For example, if the data stored in the hard disk is needed to backup to the optical storage media of the optical disc drive, the CPU 52 will send out the control command to the hard disk and the optical disc drive to set the initial condition of the data transmission between the hard disk and the optical disc drive, for example copying or moving data of a block of the first storage device 54 to be stored into a block of the second storage device 56. The first storage device 54 will then transmit data to the programmable device 58 via the first data bus 60, and the interface between transmission can be the IDE interface, the ATA interface or other types of data transmission interfaces, after the programmable device 58 receives the data transmitted from the first storage device 54, the programmable device 58 converts the data format of the data transmitted from the first storage device 54 to a corresponding data format of the second storage device 56 via a corresponding data format of the first storage device 54, for example, the programmable device 58 will convert the header and the end of the data from the original corresponding data format of the first storage device 54 to the corresponding data format of the second storage device 56 (e.g., a conversion from data format ISO 9660 of the CD to data format FAT32 of the hard disk), yet the main content of the data is not changed, in the process of data format conversion, the data to be processed is temporarily stored in the memory 66, therefore the programmable device 58 is capable of continuously receiving data transmitted by the first storage device 54. Finally, the programmable device 58 will then transmit the converted data of the data format of the corresponding second storage device 56 to the second storage device 56 via the second data bus 62, hence completing the data transmission process, and the interface between the data transmission can be the IDE interface, the ATA interface or other types of data transmission interfaces. Under the same principle, if data is transmitted from the second storage device 56 to the first storage device 54, the same transmission principle is applied as the above method, therefore, it will not be further mentioned.

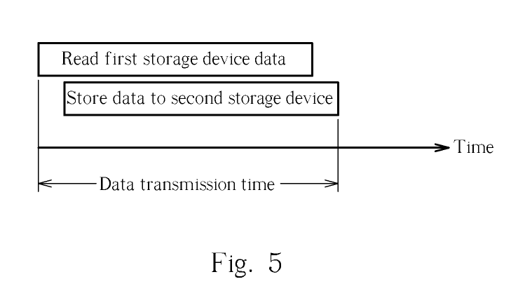

Please refer FIG. 5. FIG. 5 illustrates a transmission time diagram of a first storage device 54 transmitting data to a second storage device 56 of a computer system 50. Because the computer system 50 utilizes the programmable device 58 as a processing unit capable of transmitting data between different storage device, and because it does so via the CPU 52 to perform the process of data format conversion, therefore it can be avoided when transmitting at the same time with the CPU 52, as transmission is restricted to a unidirectional data transmission type, and this will cause a delay in the overall data transmission time. As shown in FIG. 5, when the programmable device 58 reads the data transmitted by the first storage device 54 via the first data bus 60, the programmable device 58 is capable of transmitting the data of the converted data format to the second storage device 56 via the second data bus 62 simultaneously to achieve time-delay pipeline of a type of data transmission, in this way the data transmission time is efficiently reduced so that data transmission between different storage device can be rapid.

In comparison to the conventional computer system, the computer system of the present invention utilizes a programmable device as a processing unit capable of rapidly transmitting data between different storage devices (e.g., first storage device and second storage device). Hence, the present invention can reduce the data transmission time. Additionally, by introducing a less expensive programmable device to act as a substitute for the CPU as a processing unit in the data transmission process, the workload of the CPU is reduced and the efficiency of the computer system will increase.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system capable of rapidly transmitting data between different storage devices, the computer system comprising:
a first storage device;
a second storage device;
a programmable device for converting formats of data stored the first storage device and the second storage device;
a first data bus coupled to the first storage device and the programmable device for transmitting data between the first storage device and the programmable device;
a second data bus coupled to the second storage device and the programmable device for transmitting data between the second storage device and the programmable device;
a control bus coupled to the programmable device, the first storage device and the second storage device; and
a central processing unit coupled to the first storage device, the second storage device and the programmable device for outputting a control signal to the programmable device, the first storage device and the second storage device via the control bus to set initial condition of the data transmission between the first storage device and the second storage device.

2. The computer system of claim 1 wherein the first storage device is a hard disk and the second storage device is an optical disc.

3. The computer system of claim 1 wherein the programmable device is a complex programmable logic device (CPLD).

4. The computer system of claim 1 wherein the programmable device is a field programmable gate array (FPGA).

5. The computer system of claim 1 wherein the programmable device is an application specific integrated circuit (ASIC).

6. The computer system of claim 1 wherein the programmable device comprises a memory for temporarily storing data.

7. The computer system of claim 1 wherein the first data bus and the second data bus can be an integrated drive electronics (IDE) interface or an AT attachment (ATA) interface.
